(19) United States
(12) Patent Application Publication
(10) Pub. No.: US 2026/0205720 A1
(43) Pub. Date: Jul. 16, 2026

(54) IMAGING DEVICE

(71) Applicant: Sharp Semiconductor Innovation Corporation, Tenri City (JP)

(72) Inventors: Norikazu Muraki, Tenri City (JP); Chengshin Lu, Tenri City (JP)

(21) Appl. No.: 19/433,255

(22) Filed: Dec. 26, 2025

(30) Foreign Application Priority Data
Jan. 10, 2025 (JP) 2025-004121

(51) Int. Cl. H04N 25/78; H04N 25/77

(52) U.S. Cl. CPC H04N 25/78; H04N 25/77

(57) ABSTRACT

An imaging device includes: a pixel array including an m number of first pixels and an m number of second pixels, the m number of first pixels being configured to output an m number of first pixel signals and an n number of second pixel signals, the m number of second pixels being configured to output an m number of third pixel signals and an n number of fourth pixel signals; an m number of vertical signal lines including an n number of first vertical signal lines and an n number of second vertical signal lines; and a control circuit configured to perform a first control to transmit the m number of respective first pixel signals, followed by transmitting the m number of respective third pixel signals, and a second control to transmit the n number of respective second pixel signals and the n number of respective fourth pixel signals.

### CROSS-REFERENCE TO RELATED APPLICATION

The present application claims priority from Japanese Application JP2025-004121, the content of which is hereby incorporated by reference into this application.

### BACKGROUND OF THE INVENTION

### Field of the Invention

The present disclosure relates to an imaging device.

### Description of the Related Art

Japanese Unexamined Patent Application Publication No. 2021-2807 discloses an imaging device. The imaging device includes unit pixels arranged in rows and columns. In addition, four vertical signal lines are arranged for each column. The four vertical signal lines are connected one-to-one to four unit pixels provided in each column. Its read circuit reads signals of the four unit pixels via the four vertical signal lines. This read unit can thus simultaneously read the signals of the unit pixels provided in the four columns, thereby achieving high-speed signal reading (paragraphs 0012, 0014, 0023 and 0032).

### SUMMARY OF THE INVENTION

In some cases, such imaging devices are required to reduce the number of read signals through, for instance, pixel sharing, to achieve high-speed signal reading. Unfortunately, if the number of read signals is reduced, the number of vertical signal lines that are used for signal reading is reduced, thereby failing to achieve high-speed signal reading in these imaging devices.

One aspect of the present disclosure has been made in view of this problem. It is an object of one aspect of the present disclosure to provide an imaging device that achieves high-speed pixel signal reading when, for instance, the number of read pixel signals is reduced.

An imaging device according to one aspect of the present disclosure includes the following:

a pixel array including an m number of first pixels and an m number of second pixels arranged in a vertical direction, the m number of first pixels being configured to output an m number of first pixel signals and an n number of second pixel signals, the m number of second pixels being configured to output an m number of third pixel signals and an n number of fourth pixel signals, where n is smaller than m;

an m number of vertical signal lines including an n number of first vertical signal lines and an n number of second vertical signal lines; and

a control circuit configured to perform a first control to cause the m number of vertical signal lines to transmit the m number of respective first pixel signals, followed by causing the m number of vertical signal lines to transmit the m number of respective third pixel signals, and a second control to cause the n number of first vertical signal lines to transmit the n number of respective second pixel signals, and to simultaneously cause the n number of second vertical signal lines to transmit the n number of respective fourth pixel signals.

### BRIEF DESCRIPTION OF THE DRAWINGS

FIG. 1 is a block diagram of an imaging device according to a first embodiment;

FIG. 2A is a block diagram illustrating an m number of first pixels, an m number of second pixels, an m number of vertical signal lines, and an analog-to-digital conversion circuit all included in the imaging device according to the first embodiment, under a first control of a control circuit included in the imaging device;

FIG. 2B is a block diagram illustrating the m number of first pixels, the m number of second pixels, the m number of vertical signal lines, and the analog-to-digital conversion circuit all included in the imaging device according to the first embodiment, under the first control of the control circuit included in the imaging device;

FIG. 3 is a block diagram illustrating the m number of first pixels, the m number of second pixels, the m number of vertical signal lines, and the analog-to-digital conversion circuit all included in the imaging device according to the first embodiment, under a second control of the control circuit included in the imaging device;

FIG. 4 is a flowchart showing a process of the first control, which is performed by the control circuit included in the imaging device according to the first embodiment;

FIG. 5 is a flowchart showing a process of the second control, which is performed by the control circuit included in the imaging device according to the first embodiment;

FIG. 6 is circuit diagrams of a first odd-numbered pixel and a first even-numbered pixel both included in the imaging device according to the first embodiment;

FIG. 7 is circuit diagrams of a second odd-numbered pixel and a second even-numbered pixel both included in the imaging device according to the first embodiment;

FIG. 8A is a block diagram illustrating an m number of first pixels, an m number of second pixels, an m number of vertical signal lines, and an analog-to-digital conversion circuit all included in an imaging device according to a reference example, under the second control of a control circuit included in the imaging device;

FIG. 8B is a block diagram illustrating the m number of first pixels, the m number of second pixels, the m number of vertical signal lines, and the analog-to-digital conversion circuit all included in the imaging device according to the reference example, under the second control of the control circuit included in the imaging device; and

FIG. 9 is a block diagram illustrating an m number of first pixels, an m number of second pixels, an m number of vertical signal lines, and an analog-to-digital conversion circuit all included in an imaging device according to a second embodiment, under the second control of a control circuit included in the imaging device.

### DETAILED DESCRIPTION OF THE INVENTION

Embodiments of the present disclosure will be described with reference to the drawings. It is noted that identical or equivalent elements will be denoted by the same signs throughout the drawings, and the description of redundancies will be omitted.

### First Embodiment

### 1.1 Imaging Device

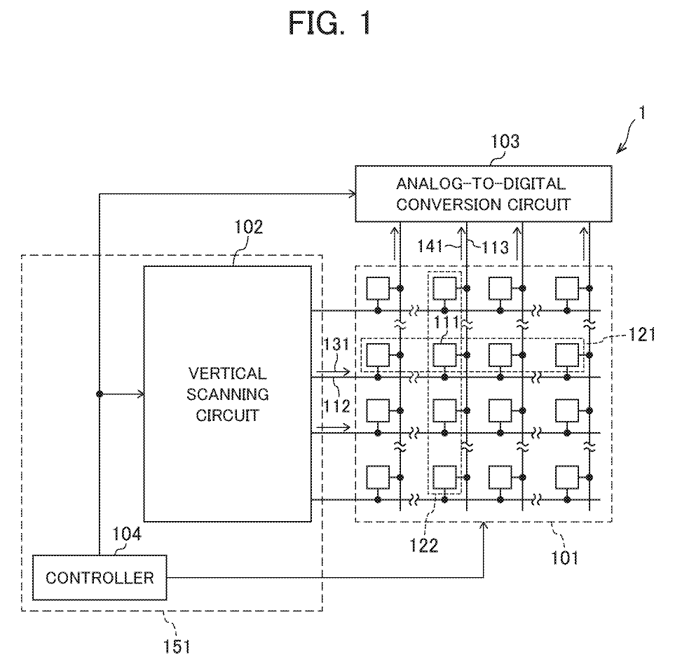

FIG. 1 is a block diagram of an imaging device according to a first embodiment.

The imaging device 1 according to the first embodiment illustrated in FIG. 1 captures an image and outputs an image signal corresponding to the captured image. The imaging device 1 is a solid-state imaging device. This solid-state imaging device is a complementary metal-oxide semiconductor (CMOS) image sensor. The technique that will be described below may be employed in imaging devices other than CMOS image sensors.

As illustrated in FIG. 1, the imaging device 1 includes a pixel unit 101, a vertical scanning circuit 102, an analog-to-digital conversion circuit 103, and a controller 104.

As illustrated in FIG. 1, the pixel unit 101 includes a p×q number of pixels 111, a p number of row selection lines 112, and a q number of vertical signal line groups 113.

The p×q number of pixels 111 are arranged in rows and columns. The p×q number of pixels 111 thus constitute a pixel array of p rows and q columns. The p×q number of pixels 111 thus include a p number of rows 121 and a q number of columns 122. A q number of pixels 111 belong to each row 121 included in the p number of rows 121. A p number of pixels 111 belong to each column 122 included in the q number of columns 122. Each pixel 111 included in the p×q number of pixels 111 receives light, generates electric charges corresponding to the intensity of the received light, and accumulates the generated electric charges. Each pixel 111 discharges the accumulated electric charges upon receiving a row selection pulse 131.

The p number of row selection lines 112 correspond one-to-one to the p number of rows 121. Each row selection line 112 included in the p number of row selection lines 112 is electrically connected to the vertical scanning circuit 102 and electrically connected to the q number of pixels 111 belonging to the row 121 to which the row selection line 112 corresponds. Each row selection line thus 112 transmits the row selection pulse 131 output from the vertical scanning circuit 102, from the vertical scanning circuit 102 to the q number of pixels 111 and supplies the transmitted row selection pulse 131 to the q number of pixels 111.

The q number of vertical signal line groups 113 correspond one-to-one to the q number of columns 122. Each vertical signal line group 113 included in the q number of vertical signal line groups 113 is electrically connected to the p number of pixels 111 belonging to the column 122 to which the vertical signal line group 113 corresponds, and it is electrically connected to the analog-to-digital conversion circuit 103. Each vertical signal line group 113 thus transmits an analog signal 141, which indicates the amount of electric charge discharged by the pixel 111 included in the p number of pixels 111, from the pixel 111 to the analog-to-digital conversion circuit 103 and supplies the transmitted analog signal 141 to the analog-to-digital conversion circuit 103. The supplied analog signal 141 has a voltage corresponding to the intensity of the light received by the pixel 111. The greater the intensity of the light received by the pixel 111 is, the smaller the voltage of the analog signal 141 is. The greater the intensity of the light received by the pixel 111 is, the greater the absolute value of the voltage of the analog signal 141 is.

The vertical scanning circuit 102 scans the pixel unit 101 in a vertical direction. The vertical scanning circuit 102 selects an r number of row selection lines 112 simultaneously from the p number of row selection lines 112 and causes the r number of selected row selection lines 112 to transmit the row selection pulse 131. The vertical scanning circuit 102 sequentially changes the r number of row selection lines 112 to be selected. In this embodiment, r is 4; further, r may be an integer equal to or greater than 2 and may be increased or decreased from 4.

Accordingly, the pixel unit 101 and the vertical scanning circuit 102 supply an r×q number of analog signals 141, which indicates the amount of electric charge discharged by an r×q number of pixels 111 belonging to an r number of rows 121 selected from the p number of rows 121, to the analog-to-digital conversion circuit 103 simultaneously. That is, the imaging device 1 can read r rows simultaneously. The pixel unit 101 and the vertical scanning circuit 102 sequentially change the r number of rows 121 to be selected.

The analog-to-digital conversion circuit 103 analog-to-digital converts the supplied r×q number of analog signals 141 into an r×q number of digital signals and outputs the r×q number of digital signals. The r×q number of output digital signals constitute an image signal. The smaller the voltage of the r×q number of analog signals 141 is, the greater each grayscale value, which is expressed by the r×q number of output digital signals, is, and the greater the absolute value of the voltage of the r×q number of analog signals 141 is, the greater each grayscale value is.

The controller 104 controls the pixel unit 101, the vertical scanning circuit 102, and the analog-to-digital conversion circuit 103 to cause the pixel unit 101, the vertical scanning circuit 102, and the analog-to-digital conversion circuit 103 to perform operations that will be described below. The controller 104 is configured by an electronic circuit. The vertical scanning circuit 102 and the controller 104 constitute a control circuit 151 that performs a first control and a second control, both of which will be described below.

### 1.2 High-Speed Pixel Signal Reading With Reduced Number Of Read Pixel Signals

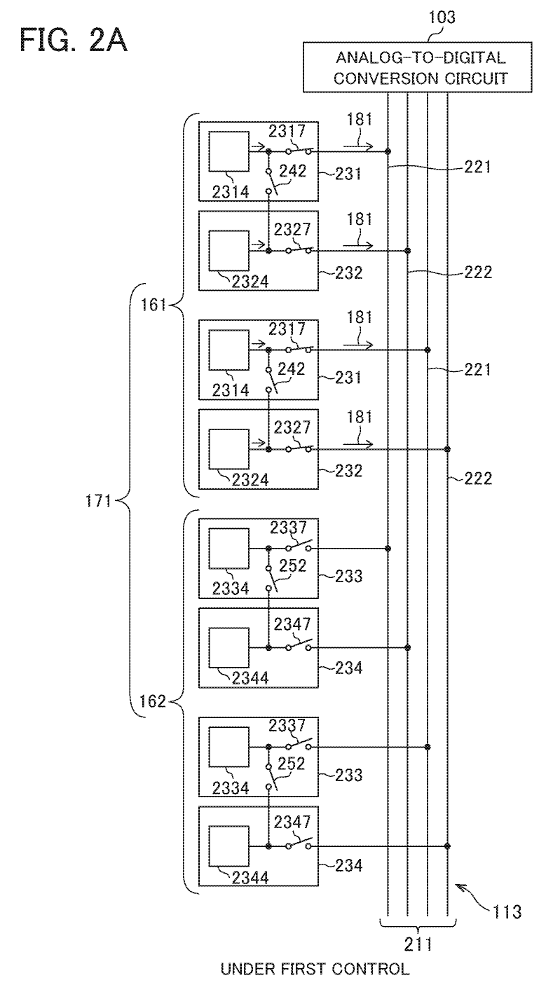

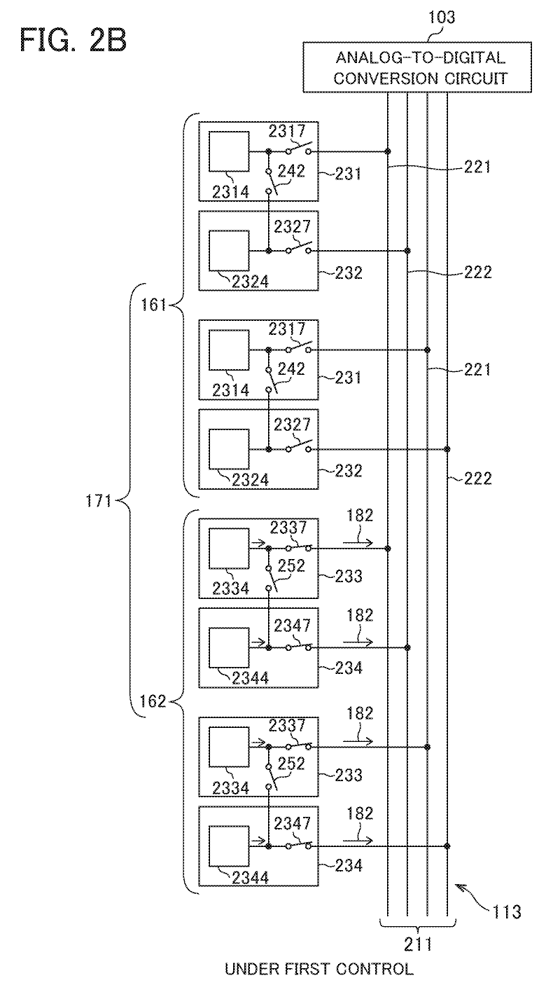

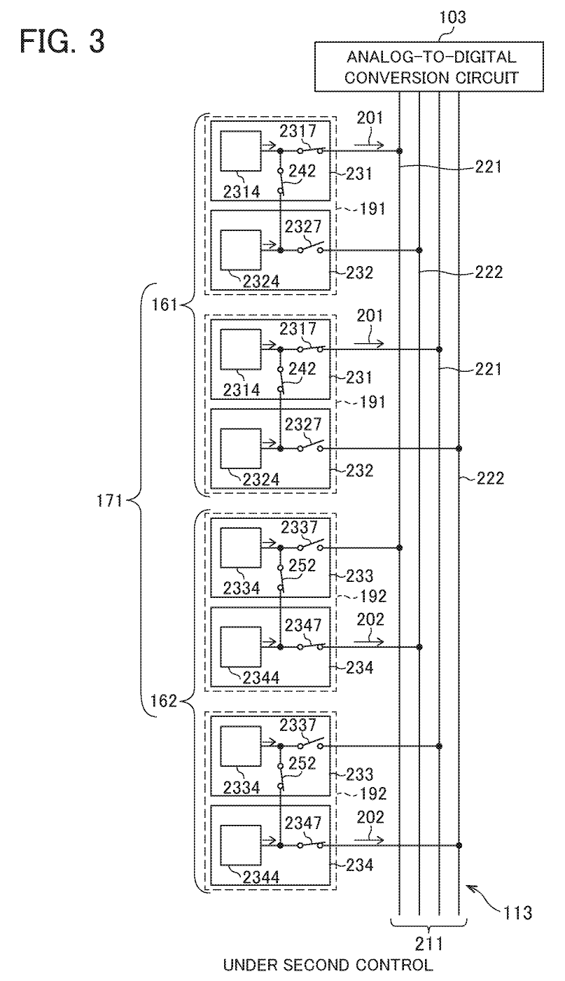

FIGS. 2A and 2B are block diagrams illustrating an m number of first pixels, an m number of second pixels, an m number of vertical signal lines, and the analog-to-digital conversion circuit all included in the imaging device according to the first embodiment, under the first control of the control circuit included in the imaging device. FIG. 3 is a block diagram illustrating the m number of first pixels, the m number of second pixels, the m number of vertical signal lines, and the analog-to-digital conversion circuit all included in the imaging device according to the first embodiment, under the second control of the control circuit included in the imaging device.

Each column 122 includes a plurality of pixel groups. The plurality of pixel groups is arranged in the vertical direction. As illustrated in FIGS. 2A, 2B and 3, each pixel group 171 included in the plurality of pixel groups includes an m number of first pixels 161 and an m number of second pixels 162. A 2m number of pixels consisting of the m number of first pixels 161 and the m number of second pixels 162 are arranged in the vertical direction.

As illustrated in FIG. 2A, when being at a maximum resolution in the vertical direction under the first control, the m number of first pixels 161 perform a first operation to output an m number of first pixel signals 181 from the m number of respective first pixels 161. As illustrated in FIG. 3, when being at a lower resolution in the vertical direction than the maximum resolution under the second control, the m number of first pixels 161 perform a second operation to form an n number of first shared pixels 191 from the m number of first pixels 161 through pixel sharing, and to output an n number of second pixel signals 201 from the n number of respective formed first shared pixels 191. As illustrated in FIG. 2B, when being at a maximum resolution in the vertical direction under the first control, the m number of second pixels 162 perform a third operation to output an m number of third pixel signals 182 from the m number of respective second pixels 162. As illustrated in FIG. 3, when being at a lower resolution in the vertical direction than the maximum resolution under the second control, the m number of second pixels 162 perform a fourth operation to form an n number of second shared pixels 192 from the m number of second pixels 162 through pixel sharing, and to output an n number of fourth pixel signals 202 from the n number of respective formed second shared pixels 192. In this embodiment, the resolution lower than the maximum resolution is a resolution that is half the maximum resolution. As such, n is 1/2 of m; in addition, n may be smaller than m and may be other than 1/2 of m.

As illustrated in FIGS. 2A, 2B and 3, each vertical signal line group 113 includes an m number of vertical signal lines 211. The m number of vertical signal lines 211 include an n number of first vertical signal lines 221 and an n number of second vertical signal lines 222.

The m number of vertical signal lines 211 are electrically connected one-to-one to the m number of first pixels 161, electrically connected one-to-one to the m number of second pixels 162, and electrically connected to the analog-to-digital conversion circuit 103. The n number of first vertical signal lines 221 are electrically connected one-to-one to the n number of first shared pixels 191 and electrically connected to the analog-to-digital conversion circuit 103. The n number of second vertical signal lines 222 are electrically connected one-to-one to the n number of second shared pixels 192 and electrically connected to the analog-to-digital conversion circuit 103. As such, the m number of vertical signal lines 211 transmit the m number of respective first pixel signals 181 from the m number of respective first pixels 161 to the analog-to-digital conversion circuit 103 and transmits the m number of respective third pixel signals 182 from the m number of respective second pixels 162 to the analog-to-digital conversion circuit 103. The n number of first vertical signal lines 221 transmit the n number of respective second pixel signals 201 from the n number of respective first shared pixels 191 to the analog-to-digital conversion circuit 103. The n number of second vertical signal lines 222 transmit the n number of respective fourth pixel signals 202 from the n number of respective second shared pixels 192 to the analog-to-digital conversion circuit 103.

The analog-to-digital conversion circuit 103 analog-to-digital converts the m number of transmitted first pixel signals 181 into an m number of digital signals individually, analog-to-digital converts the m number of transmitted third pixel signals 182 into an m number of digital signals individually, analog-to-digital converts the n number of transmitted second pixel signals 201 into an n number of digital signals individually, and analog-to-digital converts the n number of transmitted fourth pixel signals 202 into an n number of digital signals individually.

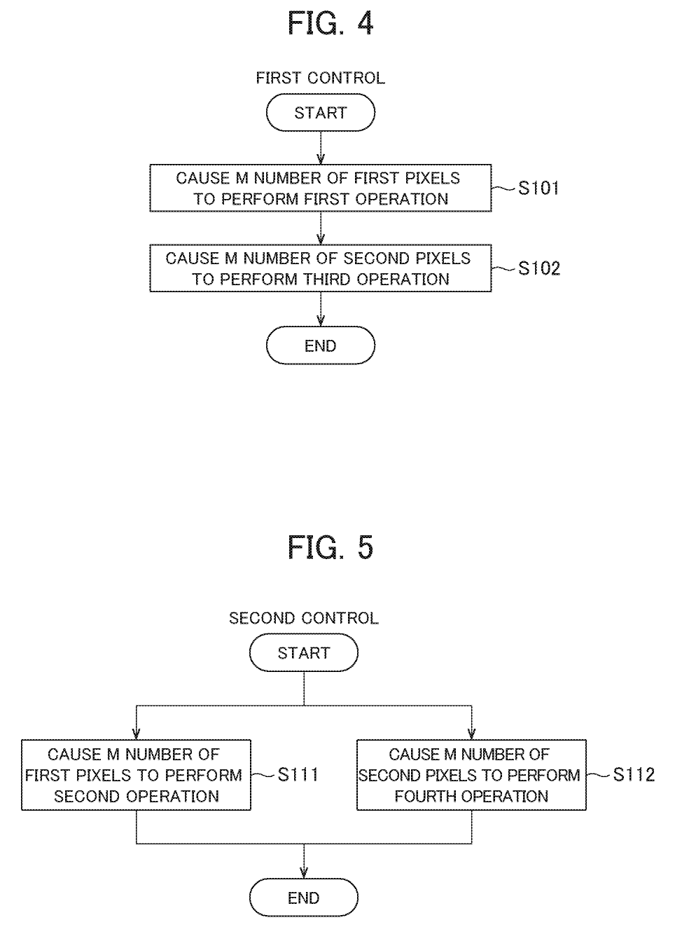

FIG. 4 is a flowchart showing a process of the first control, which is performed by the control circuit included in the imaging device according to the first embodiment.

When performing the first control to set the resolution in the vertical direction at a maximum resolution, the control circuit 151 executes, for each pixel group 171, Step S101 shown in FIG. 4, followed by executing Step S102 shown in FIG. 4.

In Step S101, the control circuit 151 controls the m number of first pixels 161 to perform the first operation. The control circuit 151 thus controls the m number of first pixels 161 to output the m number of first pixel signals 181 and controls the m number of vertical signal lines 211 to transmit the m number of output first pixel signals 181.

In Step S102, the control circuit 151 controls the m number of second pixels 162 to perform the third operation. The control circuit 151 thus controls the m number of second pixels 162 to output the m number of respective third pixel signals 182 and controls the m number of vertical signal lines 211 to transmit the m number of respective output third pixel signals 182.

FIG. 5 is a flowchart showing a process of the second control, which is performed by the control circuit included in the imaging device according to the first embodiment.

When performing the second control to set the resolution in the vertical direction at a lower resolution than the maximum resolution, the control circuit 151 executes, for each pixel group 171, Step S111 and Step S112 shown in FIG. 5 simultaneously.

In Step S111, the control circuit 151 controls the m number of first pixels 161 to perform the second operation. The control circuit 151 thus controls the m number of first pixels 161 to output the n number of second pixel signals 201 and controls the n number of first vertical signal lines 221 to transmit the n number of output second pixel signals 201.

In Step S112, the control circuit 151 controls the m number of second pixels 162 to perform the fourth operation. The control circuit 151 thus controls the m number of second pixels 162 to output the n number of fourth pixel signals 202 and controls the n number of second vertical signal lines 222 to transmit the n number of output fourth pixel signals 202.

When performing the first control, the control circuit 151 controls the m number of vertical signal lines 211 to transmit the m number of first pixel signals 181, as illustrated in FIG. 2A, followed by controlling the m number of vertical signal lines 211 to transmit the m number of third pixel signals 182, as illustrated in FIG. 2B. Under the first control, the m number of vertical signal lines 211 cannot be used, simultaneously for reading the m number of first pixel signals 181 and reading the m number of third pixel signals 182. Thus, the reading of the m number of first pixel signals 181 and the reading of the m number of third pixel signals 182 are performed in two cycles.

When performing the second control, the control circuit 151 controls the n number of first vertical signal lines 221 to transmit the n number of second pixel signals 201, and simultaneously controls the n number of second vertical signal lines 222 to transmit the n number of fourth pixel signals 202. Under the second control, the n number of first vertical signal lines 221 can used for reading the n number of second pixel signals 201, and simultaneously, the n number of second vertical signal lines 222 can be used for reading the n number of fourth pixel signals 202. Thus, the reading of the n number of second pixel signals 201 and the reading of the n number of fourth pixel signals 202 are performed in one cycle. Consequently, the n number of second pixel signals 201 and the n number of fourth pixel signals 202 can be read at the lower resolution in the vertical direction than the maximum resolution with higher speed than the the m number of first pixel signals 181 and the m number of third pixel signals 182 can at the maximum resolution in the vertical direction. This achieves high-speed pixel signal reading when the number of read pixel signals is reduced. When the lower resolution than the maximum resolution is a resolution that is half the maximum resolution, the time necessary for reading the n number of second pixel signals 201 and the n number of fourth pixel signals 202 at the lower resolution in the vertical direction than the maximum resolution is half the time necessary for reading the m number of first pixel signals 181 and the m number of third pixel signals 182 at the maximum resolution in the vertical direction.

In the first embodiment, the resolution in the vertical direction is half the maximum resolution when it is lower than the maximum resolution. When the resolution in the vertical direction is half the maximum, each pixel group 171 is divided into two sets of pixel groups: the m number of first pixels 161 and the m number of second pixels 162, and the m number of vertical signal lines 211 is divided into two sets of vertical signal line groups: the n number of first vertical signal lines 221 and the n number of second vertical signal lines 222; the pixel signals output by the two sets of pixel groups are transmitted to the respective two sets of vertical signal line groups. However, the resolution in the vertical direction may be equal to or smaller than one-third of the maximum resolution. When the resolution in the vertical direction is 1/N of the maximum resolution, each pixel group 171 may be divided into N sets of pixel groups, and the m number of vertical signal lines 211 may be divided into N sets of vertical signal line groups; the pixel signals output by the N sets of pixel groups may be transmitted by the respective N sets of vertical signal line groups.

### 1.3 Pixel Circuit

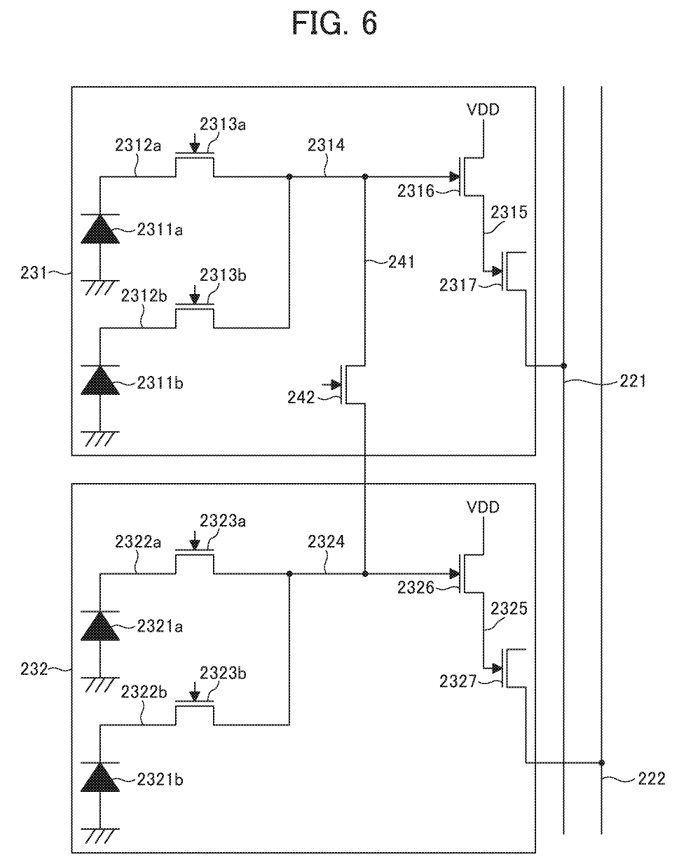

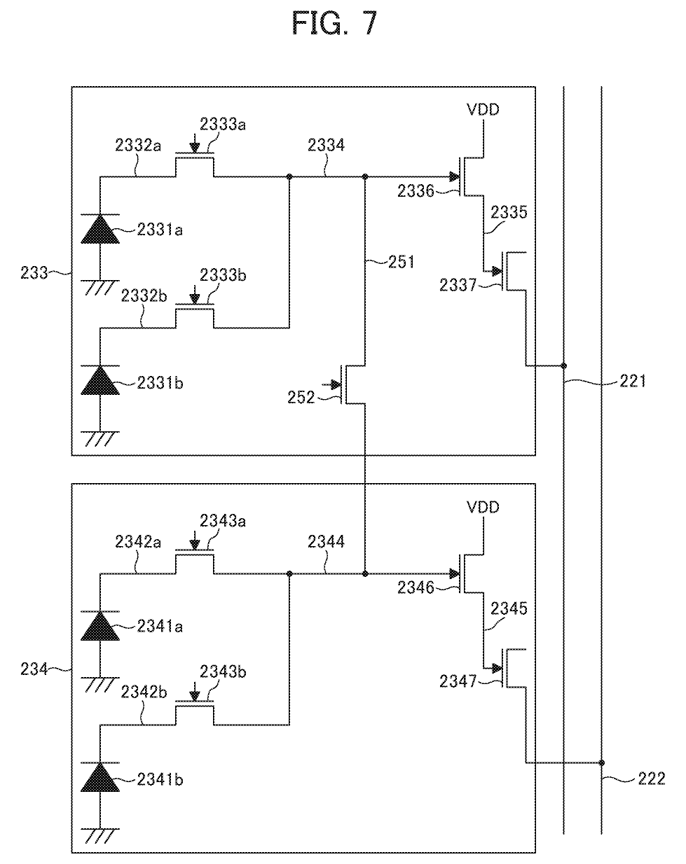

FIG. 6 is circuit diagrams of a first odd-numbered pixel and a first even-numbered pixel both included in the imaging device according to the first embodiment. FIG. 7 is circuit diagrams of a second odd-numbered pixel and a second even-numbered pixel both included in the imaging device according to the first embodiment. In FIGS. 6 and 7, reset transistors provided in the respective first odd-numbered pixel, first even-numbered pixel, second odd-numbered pixel, and second even-numbered pixel are omitted.

As illustrated in FIGS. 2A, 2B, 3, 6, and 7, the m number of first pixels 161 include an n number of first odd-numbered pixels 231 and an n number of first even-numbered pixels 232. The m number of second pixels 162 include an n number of second odd-numbered pixels 233 and an n number of second even-numbered pixels 234.

The n number of first odd-numbered pixels 231 are pixels disposed in odd-numbered places in the vertical arrangement of the m number of first pixels 161. The n number of first even-numbered pixels 232 are pixels disposed in even-numbered places in the vertical arrangement of the m number of first pixels 161. The first odd-numbered pixels 231 and the first even-numbered pixels 232 are arranged alternately. The n number of second odd-numbered pixels 233 are pixels disposed in odd-numbered places in the vertical arrangement of the m number of second pixels 162. The n number of second even-numbered pixels 234 are pixels disposed in even-numbered places in the vertical arrangement of the m number of second pixels 162. Thus, the second odd-numbered pixels 233 and the second even-numbered pixels 234 are arranged alternately.

As illustrated in FIGS. 2A, 2B, 3, and 6, each first odd-numbered pixel 231 included in the n number of first odd-numbered pixels 231 includes first photodiodes 2311a and 2311b, first charge transfer paths 2312a and 2312b, first transfer gate transistors 2313a and 2313b, a first floating diffusion (FD) 2314, a first charge release path 2315, a first amplification transistor 2316, and a first row selection transistor 2317. Each first even-numbered pixel 232 included in the n number of first even-numbered pixels 232 includes second photodiodes 2321a and 2321b, second charge transfer paths 2322a and 2322b, second transfer gate transistors 2323a and 2323b, a second FD 2314, a second charge release path 2325, a second amplification transistor 2326, and a second row selection transistor 2327. As illustrated in FIGS. 2A, 2B, 3, and 7, each second odd-numbered pixel 233 included in the n number of second odd-numbered pixels 233 includes third photodiodes 2331a and 2331b, third charge transfer paths 2332a and 2332b, third transfer gate transistors 2333a and 2333b, a third FD 2335, a third charge release path 2335, a third amplification transistor 2336, and a third row selection transistor 2337. Each second even-numbered pixel 234 included in the n number of second even-numbered pixels 234 includes fourth photodiodes 2341a and 2341b, fourth charge transfer paths 2342a and 2342b, fourth transfer gate transistors 2343a and 2343b, a fourth FD 2344, a fourth charge release path 2345, a fourth amplification transistor 2346, and a fourth row selection transistor 2347.

Each of the first photodiodes 2311a and 2311b generates an electric charge corresponding to the intensity of light received by the corresponding first odd-numbered pixel 231. Each of the second photodiodes 2321a and 2321b generates an electric charge corresponding to the intensity of light received by the corresponding first even-numbered pixel 232. Each of the third photodiodes 2331a and 2331b generates an electric charge corresponding to the intensity of light received by the corresponding second odd-numbered pixel 233. Each of the fourth photodiodes 2341a and 2341b generates an electric charge corresponding to the intensity of light received by the corresponding second even-numbered pixel 234.

The first charge transfer paths 2312a and 2312b extend from the first photodiodes 2311a and 2311b, respectively, to the first FD 2314. The second charge transfer paths 2322a and 2322b extend from the second photodiodes 2321a and 2321b, respectively, to the second FD 2324. The third charge transfer paths 2332a and 2332b extend from the third photodiodes 2331a and 2331b, respectively, to the third FD 2334. The fourth charge transfer paths 2342a and 2342b extend from the fourth photodiodes 2341a and 2341b, respectively, to the fourth FD 2344.

The first charge transfer paths 2312a and 2312b transfer the electric charges generated by the first photodiodes 2311a and 2311b from the first photodiodes 2311a and 2311b, respectively, to the first FD 2314 when they are closed, and the first charge transfer paths 2312a and 2312b do not transfer the electric charges when they are open. The second charge transfer paths 2322a and 2322b transfer the electric charges generated by the second photodiodes 2321a and 2321b from the second photodiodes 2321a and 2321b, respectively, to the second FD 2324 when they are closed, and the second charge transfer paths 2322a and 2322b do not transfer the electric charges when they are open. The third charge transfer paths 2332a and 2332b transfer the electric charges generated by the third photodiodes 2331a and 2331b from the third photodiodes 2331a and 2331b, respectively, to the third FD 2334 when they are closed, and the third charge transfer paths 2332a and 2332b do not transfer the electric charges when they are open. The fourth charge transfer paths 2342a and 2342b transfer the electric charges generated by the fourth photodiodes 2341a and 2341b from the fourth photodiodes 2341a and 2341b, respectively, to the fourth FD 2344 when they are closed, and the fourth charge transfer paths 2342a and 2342b do not transfer the electric charges when they are open.

The first transfer gate transistors 2313a and 2313b open and close the first charge transfer paths 2312a and 2312b, respectively. The second transfer gate transistors 2323a and 2323b open and close the second charge transfer paths 2322a and 2322b, respectively. The third transfer gate transistors 2333a and 2333b open and close the third charge transfer paths 2332a and 2332b, respectively. The fourth transfer gate transistors 2343a and 2343b open and close the fourth charge transfer paths 2342a and 2342b, respectively.

The first FD 2314 accumulates the electric charges transferred by the first charge transfer paths 2312a and 2312b. The second FD 2324 accumulates the electric charges transferred by the second charge transfer paths 2322a and 2322b. The third FD 2334 accumulates the electric charges transferred by the third charge transfer paths 2332a and 2332b. The fourth FD 2344 accumulates the electric charges transferred by the fourth charge transfer paths 2342a and 2342b.

An n number of first charge release paths 2315 included in the n number of first odd-numbered pixels 231 extend from an n number of respective first FDs 2314 included in the n number of first odd-numbered pixels 231 to the n number of respective first vertical signal lines 221. An n number of second charge release paths 2325 included in the n number of first even-numbered pixels 232 extend from an n number of respective second FDs 2324 included in the n number of first even-numbered pixels 232 to the n number of respective second vertical signal lines 222. An n number of third charge release paths 2335 included in the n number of second odd-numbered pixels 233 extend from an n number of respective third FDs 2334 included in the n number of second odd-numbered pixels 233 to the n number of respective first vertical signal lines 221. An n number of fourth charge release paths 2345 included in the n number of second even-numbered pixels 234 extend from an n number of respective fourth FDs 2344 included in the n number of second even-numbered pixels 234 to the n number of respective second vertical signal lines 222.

The n number of first charge release paths 2315 transmit the electric charges accumulated in the n number of first FDs 2314, from the n number of respective first FDs 2314 to the n number of respective first vertical signal lines 221 when they are closed, and the n number of first charge release paths 2315 do not transfer the electric charges when they are open. The n number of second charge release paths 2325 transmit the electric charges accumulated in the n number of second FDs 2324, from the n number of respective second FDs 2324 to the n number of respective second vertical signal lines 222 when they are closed, and the n number of second charge release paths 2325 do not transfer the electric charges when they are open. The n number of third charge release paths 2335 transmit the electric charges accumulated in the n number of third FDs 2334, from the n number of respective third FDs 2334 to the n number of respective first vertical signal lines 221 when they are closed, and the n number of third charge release paths 2335 do not transfer the electric charges when they are open. The n number of fourth charge release path 2345 transmit the electric charges accumulated in the n number of fourth FDs 2344, from the n number of respective fourth FDs 2344 to the n number of respective second vertical signal lines 222 when they are closed, and the n number of fourth charge release paths 2345 do not transfer the electric charges when they are open.

The first amplification transistor 2316 amplifies the electric charge released by the first charge release path 2315. The second amplification transistor 2326 amplifies the electric charge released by the second charge release path 2325. The third amplification transistor 2336 amplifies the electric charge released by the third charge release path 2335. The fourth amplification transistor 2346 amplifies the electric charge released by the fourth charge release path 2345.

An n number of first row selection transistors 2317 included in the n number of first odd-numbered pixels 231 open and close the n number of respective first charge release paths 2315. An n number of second row selection transistors 2327 included in the n number of first even-numbered pixels 232 open and close the n number of respective second charge release paths 2325. An n number of third row selection transistors 2337 included in the n number of second odd-numbered pixels 233 open and close the n number of respective third charge release paths 2335. An n number of fourth row selection transistors 2347 included in the n number of second even-numbered pixels 234 open and close the n number of respective fourth charge release paths 2345.

The m number of first pixels 161 include an n number of first charge mixing paths 241 and an n number of first transistors 242. The m number of second pixels 162 include an n number of second charge mixing paths 251 and an n number of second transistors 252.

The n number of first charge mixing paths 241 extend from the n number of respective first FDs 2314 to the n number of respective second FDs 2324. The n number of second charge mixing paths 251 extend from the n number of respective third FDs 2334 to the n number of respective fourth FDs 2344.

The first charge mixing path 241 brings the first FD 2314 and second FD 2324 into mutual conduction when it is closed, and the first charge mixing path 241 does not bring the first FD 2314 and second FD 2324 into mutual conduction when it is open. When the first charge mixing path 241 is closed, the electric charges accumulated in the first FD 2314 and the electric charges accumulated in the second FD 2324 are mixed together. This integrates the first FD 2314 and the second FD 2324 together, thus constituting the first shared pixel 191 including the integrated FD. The second charge mixing path 251 brings the third FD 2334 and fourth FD 2344 into mutual conduction when it is closed, and the second charge mixing path 251 does not bring the third FD 2334 and fourth FD 2344 into mutual conduction when it is open. When the second charge mixing path 251 is closed, the electric charges accumulated in the third FD 2334 and the electric charges accumulated in the fourth FD 2344 are mixed together. This integrates the third FD 2334 and the fourth FD 2344 together, thus constituting the second shared pixel 192 including the integrated FD.

The electric charges accumulated in the integrated FD included in the first shared pixel 191 can be released by either of the first charge release path 2315 and second charge release path 2325. The electric charges accumulated in the integrated FD included in the second shared pixel 192 can be released by either of the third charge release path 2335 and fourth charge release path 2345. Under the second control, to use all of the m number of vertical signal lines 211, the electric charges accumulated in the integrated FD included in the first shared pixel 191 are released by the first charge release path 2315 electrically connected to the first vertical signal line 221. In addition, the electric charges accumulated in the integrated FD included in the second shared pixel 192 are released by the fourth charge release path 2345 electrically connected to the second vertical signal line 222.

The n number of first transistors 242 open and close the n number of respective first charge mixing paths 241. The n number of second transistors 252 open and close the n number of respective second charge mixing paths 251.

In Steps S101 and S102, which are executed in performing the first control, the control circuit 151, as illustrated in FIGS. 2A and 2B, inputs an OFF signal to the n number of first transistors 242 to cause the n number of first transistors 242 to open the n number of first charge mixing paths 241, and inputs an OFF signal to the n number of second transistors 252 to cause the n number of second transistors 252 to open the n number of second charge mixing paths 251. This enables the m number of first pixels 161 to accumulate electric charges in FDs independent of each other, to output the m number of first pixel signals 181, and enables the m number of second pixels 162 to accumulate electric charges in FDs independent of each other, to output the m number of third pixel signals 182.

In Step S101, which is executed in performing the first control, the control circuit 151, as illustrated in FIG. 2A, inputs an ON signal to the n number of first row selection transistors 2317 to cause the n number of first row selection transistors 2317 to close the n number of first charge release paths 2315, inputs an ON signal to the n number of second row selection transistors 2327 to cause the n number of second row selection transistors 2327 to close the n number of second charge release paths 2325, inputs an OFF signal to the n number of third row selection transistors 2337 to cause the n number of third row selection transistors 2337 to open the n number of third charge release paths 2335, and inputs an OFF signal to the n number of fourth row selection transistors 2347 to cause the n number of fourth row selection transistors 2347 to open the n number of fourth charge release paths 2345. The control circuit 151 thus controls the m number of first pixels 161 to output the m number of first pixel signals 181 and controls the m number of second pixels 162 not to output pixel signals.

In Step S102, which is executed in performing the first control, the control circuit 151, as illustrated in FIG. 2B, inputs an OFF signal to the n number of first row selection transistors 2317 to cause the n number of first row selection transistors 2317 to open the n number of first charge release paths 2315, inputs an OFF signal to the n number of second row selection transistors 2327 to cause the n number of second row selection transistors 2327 to open the n number of second charge release paths 2325, inputs an ON signal to the n number of third row selection transistors 2337 to cause the n number of third row selection transistors 2337 to close the n number of third charge release paths 2335, and inputs an ON signal to the n number of fourth row selection transistors 2347 to cause the n number of fourth row selection transistors 2347 to close the n number of fourth charge release paths 2345. The control circuit 151 thus controls the m number of first pixels 161 not to output pixel signals and controls the m number of second pixels 162 to output the m number of third pixel signals 182.

In Steps S111 and S112, which are executed in performing the second control, the control circuit 151, as illustrated in FIG. 3, inputs an ON signal to the n number of first transistors 242 to cause the n number of first transistors 242 to close the n number of first charge mixing paths 241, and inputs an ON signal to the n number of second transistors 252 to cause the n number of second transistors 252 to close the n number of second charge mixing paths 251. This forms the n number of first shared pixels 191 and the n number of second shared pixels 192.

In Step S111, which is executed in performing the second control, the control circuit 151, as illustrated in FIG. 3, inputs an ON signal to the n number of first row selection transistors 2317 to cause the n number of first row selection transistors 2317 to close the n number of first charge release paths 2315, and inputs an OFF signal to the n number of second row selection transistors 2327 to cause the n number of second row selection transistors 2327 to open the n number of second charge release paths 2325. The control circuit 151 thus controls the n number of first shared pixels 191 to output the n number of second pixel signals 201 via the n number of first charge release paths 2315.

In Step S112, which is executed in performing the second control, the control circuit 151, as illustrated in FIG. 3, inputs an OFF signal to the n number of third row selection transistors 2337 to cause the n number of third row selection transistors 2337 to open the n number of third charge release paths 2335, and inputs an ON signal to the n number of fourth row selection transistors 2347 to cause the n number of fourth row selection transistors 2347 to close the n number of fourth charge release paths 2345. The control circuit 151 thus controls the n number of second shared pixels 192 to output the n number of fourth pixel signals 202 via the n number of fourth charge release paths 2345.

Under the second control, a control signal that is input to a row selection transistor for every four pixels is inverted between ON and OFF signals.

The electric charges generated by the first photodiode 2311a, the second photodiode 2321a, the third photodiode 2331a, and the fourth photodiode 2341a are firstly transferred to and released from the first FD 2314, the second FD 2324, the third FD 2334, and the fourth FD 2344. The electric charges generated by the first photodiode 2311b, the second photodiode 2321b, the third photodiode 2331b, and the fourth photodiode 2341b are later transferred to and released from the first FD 2314, the second FD 2324, the third FD 2334, and the fourth FD 2344. That is, the first photodiode 2311a, the second photodiode 2321a, the third photodiode 2331a, and the fourth photodiode 2341a are read firstly. In addition, the first photodiode 2311b, the second photodiode 2321b, the third photodiode 2331b, and the fourth photodiode 2341b are read later.

### 1.4 Comparison Between Reference Example And First Embodiment

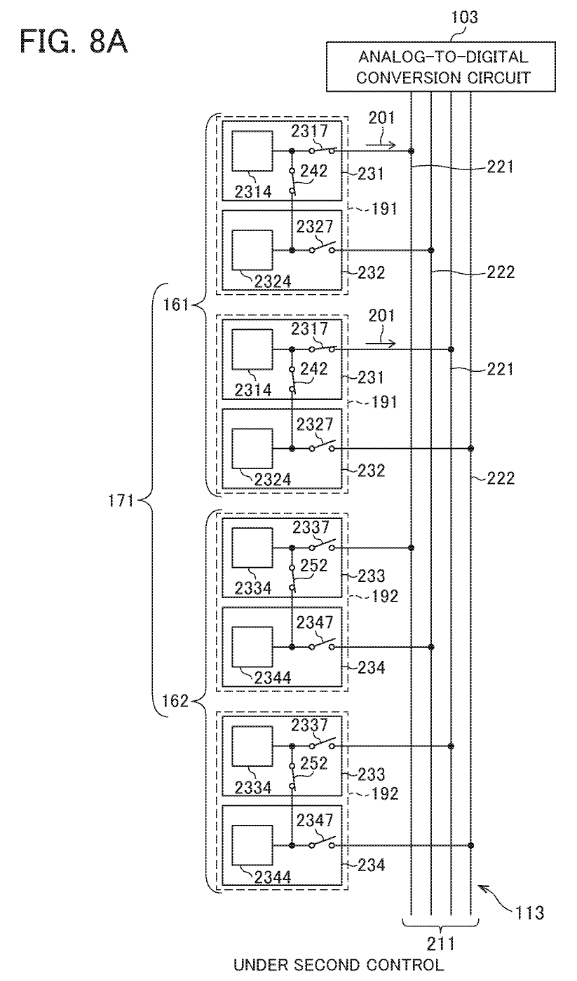

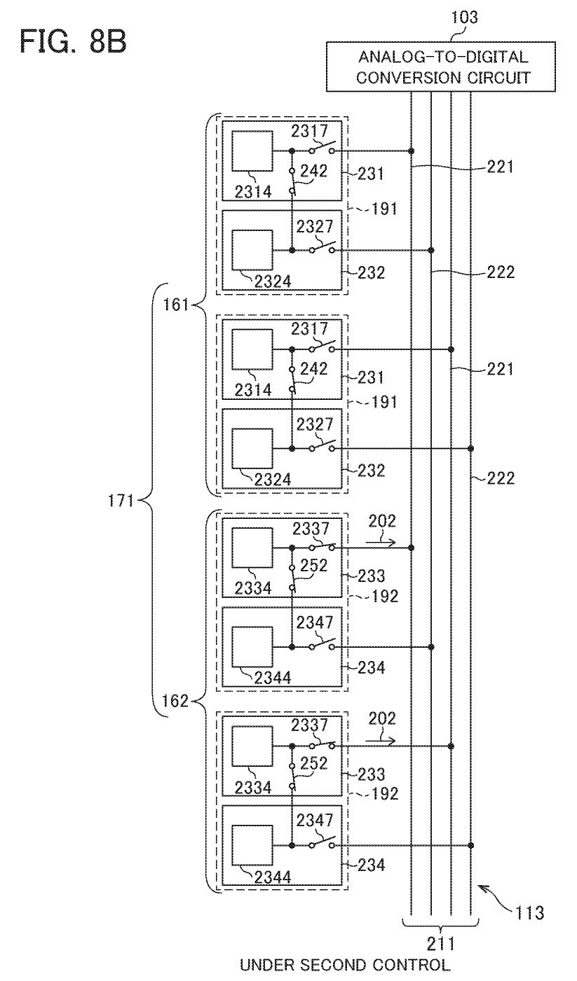

FIGS. 8A and 8B are block diagrams illustrating an m number of first pixels, an m number of second pixels, an m number of vertical signal lines, and an analog-to-digital conversion circuit all included in an imaging device according to a reference example, under the second control of a control circuit included in the imaging device.

In the reference example, as illustrated in FIG. 8A, the n number of first vertical signal lines 221 transmit the n number of second pixel signals 201 output by the n number of first shared pixels 191, from the n number of respective first shared pixels 191 to the analog-to-digital conversion circuit 103. As illustrated in FIG. 8B, the n number of first vertical signal lines 221 also transmit the n number of fourth pixel signals 202 output by the n number of second shared pixels 192, from the n number of respective second shared pixels 192 to the analog-to-digital conversion circuit 103. However, the n number of first vertical signal lines 221 cannot be used, simultaneously for reading the n number of second pixel signals 201 and reading the n number of fourth pixel signals 202. Thus, in the imaging device according to the reference example, the n number of first vertical signal lines 221 transmit the n number of fourth pixel signals 202 after the n number of first vertical signal lines 221 transmit the n number of second pixel signals 201. The n number of second vertical signal lines 222 are not used for pixel signal reading. A unit included in the analog-to-digital conversion circuit 103 and configured to analog-to-digital convert the pixel signals transmitted by the n number of second vertical signal lines 222 is also not used for analog-to-digital pixel signal conversion. As such, each vertical signal line group 113 and the analog-to-digital conversion circuit 103 cannot exert their capabilities when the number of read pixel signals is reduced, thereby failing to read the pixel signals at high speed.

In contrast to this, in the first embodiment, the n number of first vertical signal lines 221 transmit the n number of respective second pixel signals 201 output by the n number of first shared pixels 191, from the n number of first shared pixels 191 to the analog-to-digital conversion circuit 103, as illustrated in FIG. 3. In addition, the n number of second vertical signal lines 222 transmit the n number of respective fourth pixel signals 202 output by the n number of second shared pixels 192, from the n number of second shared pixels 192 to the analog-to-digital conversion circuit 103. The n number of first vertical signal lines 221 can be used for reading the n number of second pixel signals 201, and simultaneously, the n number of second vertical signal lines 222 can be used for reading the n number of fourth pixel signals 202. Thus, in the imaging device 1 according to the first embodiment, the n number of first vertical signal lines 221 transmit the n number of second pixel signals 201, and simultaneously, the n number of second vertical signal lines 222 transmit the n number of fourth pixel signals 202. All of the m number of vertical signal lines 211 are used. The unit included in the analog-to-digital conversion circuit 103 and configured to analog-to-digital convert the pixel signals transmitted by the n number of second vertical signal lines 222 is used as well. As such, each vertical signal line group 113 and the analog-to-digital conversion circuit 103 can exert their capabilities when the number of read pixel signals is reduced, thereby achieving high-speed pixel signal reading.

### Second Embodiment

The following describes a point in which a second embodiment is different from the first embodiment. With regard to what will not be described, a configuration similar to the configuration applied in the first embodiment will be applied in the second embodiment as well.

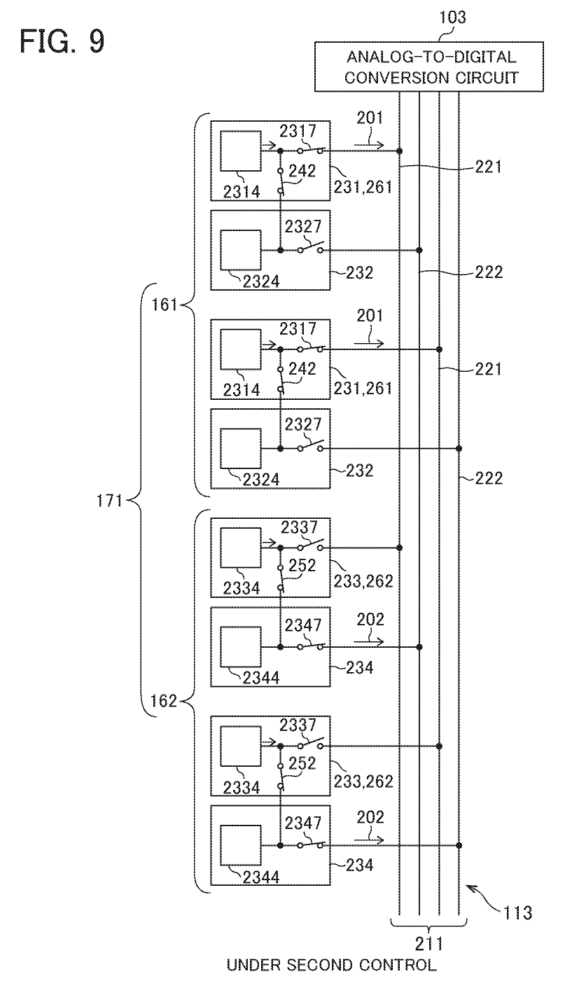

FIG. 9 is a block diagram illustrating an m number of first pixels, an m number of second pixels, an m number of vertical signal lines, and an analog-to-digital conversion circuit all included in an imaging device according to the second embodiment, under the second control of a control circuit included in the imaging device.

In the second embodiment, when being at a lower resolution in the vertical direction than the maximum resolution under the second control, the m number of first pixels 161 perform the second operation to output the n number of second pixel signals 201 from an n number of first remaining pixels 261 left out of the m number of first pixels 161 by pixel thinning-out. Further, when being at a lower resolution in the vertical direction than the maximum resolution under the second control, the m number of second pixels 162 perform the fourth operation to output the n number of fourth pixel signals 202 from an n number of second remaining pixels 262 left out of the m number of second pixels 162 by pixel thinning-out. In such an instance as well, where resolution is lowered by pixel thinning-out, high-speed pixel signal reading is achieved when the number of read pixel signals is reduced, like in an instance where resolution is lowered by pixel sharing.

The present disclosure is not limited to the above-described embodiments. The present disclosure may be replaced with a configuration substantially identical to those described in the above-described embodiments, a configuration that provides the same action and effect as those described in the above-described embodiments, or a configuration that achieves the same object as those described in the above-described embodiments.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An imaging device comprising:
a pixel array including an m number of first pixels and an m number of second pixels arranged in a vertical direction, the m number of first pixels being configured to output an m number of first pixel signals and an n number of second pixel signals, the m number of second pixels being configured to output an m number of third pixel signals and an n number of fourth pixel signals, where n is smaller than m;
an m number of vertical signal lines including an n number of first vertical signal lines and an n number of second vertical signal lines; and
a control circuit configured to perform
a first control to cause the m number of vertical signal lines to transmit the m number of respective first pixel signals, followed by causing the m number of vertical signal lines to transmit the m number of respective third pixel signals, and
a second control to cause the n number of first vertical signal lines to transmit the n number of respective second pixel signals, and to simultaneously cause the n number of second vertical signal lines to transmit the n number of respective fourth pixel signals.

2. The imaging device according to claim 1,
wherein the m number of first pixels perform
a first operation to output the m number of respective first pixel signals from the m number of first pixels, and
a second operation to output the n number of respective second pixel signals from an n number of first shared pixels formed from the m number of first pixels through pixel sharing,
wherein the m number of second pixels perform
a third operation to output the m number of respective third pixel signals from the m number of second pixels, and
a fourth operation to output the n number of respective fourth pixel signals from an n number of second shared pixels formed from the m number of second pixels through pixel sharing,
wherein the first control includes causing the m number of first pixels to perform the first operation, followed by causing the m number of second pixels to perform the third operation, and
wherein the second control includes causing the m number of first pixels to perform the second operation, and simultaneously causing the m number of second pixels to perform the fourth operation.

3. The imaging device according to claim 1,
wherein the m number of first pixels perform
a first operation to output the m number of respective first pixel signals from the m number of first pixels, and
a second operation to output the n number of respective second pixel signals from an n number of first remaining pixels left out of the m number of first pixels by pixel thinning-out,
wherein the m number of second pixels perform
a third operation to output the m number of respective third pixel signals from the m number of second pixels, and
a fourth operation to output the n number of respective fourth pixel signals from an n number of second remaining pixels left out of the m number of second pixels by pixel thinning-out,
wherein the first control includes causing the m number of first pixels to perform the first operation, followed by causing the m number of second pixels to perform the third operation, and
wherein the second control includes causing the m number of first pixels to perform the second operation, and simultaneously causing the m number of second pixels to perform the fourth operation.

4. The imaging device according to claim 1,
wherein the m number of first pixels include
an n number of first floating diffusions,
an n number of first charge release paths extending from the n number of respective first floating diffusions to the n number of respective first vertical signal lines,
an n number of first row selection transistors configured to open and close the n number of respective first charge release paths,
an n number of second floating diffusions,
an n number of second charge release paths extending from the n number of respective second floating diffusions to the n number of respective second vertical signal lines, and
an n number of second row selection transistors configured to open and close the n number of respective second charge release paths,
wherein the m number of second pixels include
an n number of third floating diffusions,
an n number of third charge release paths extending from the n number of respective third floating diffusions to the n number of respective first vertical signal lines,
an n number of third row selection transistors configured to open and close the n number of respective third charge release paths,
an n number of fourth floating diffusions,
an n number of fourth charge release paths extending from the n number of respective fourth floating diffusions to the n number of respective second vertical signal lines, and
an n number of fourth row selection transistors configured to open and close the n number of respective fourth charge release paths,
wherein the first control includes
causing the n number of first row selection transistors to close the n number of first charge release paths,
causing the n number of second row selection transistors to close the n number of second charge release paths,
causing the n number of third row selection transistors to open the n number of third charge release paths,
causing the n number of fourth row selection transistors to open the n number of fourth charge release paths, followed by causing the n number of first row selection transistors to open the n number of first charge release paths,
causing the n number of second row selection transistors to open the n number of second charge release paths,
causing the n number of third row selection transistors to close the n number of third charge release paths, and
causing the n number of fourth row selection transistors to close the n number of fourth charge release paths, and
wherein the second control includes
causing the n number of first row selection transistors to close the n number of first charge release paths,
causing the n number of second row selection transistors to open the n number of second charge release paths, and simultaneously causing the n number of third row selection transistors to open the n number of third charge release paths, and
causing the n number of fourth row selection transistors to close the n number of fourth charge release paths.

5. The imaging device according to claim 4,
wherein the m number of first pixels include
an n number of first charge mixing paths extending from the n number of respective first floating diffusions to the n number of respective second floating diffusions, and
an n number of first transistors configured to open and close the n number of respective first charge mixing paths,
wherein the m number of second pixels include
an n number of second charge mixing paths extending from the n number of respective third floating diffusions to the n number of respective fourth floating diffusions, and
an n number of second transistors configured to open and close the n number of respective second charge mixing paths,
wherein the first control includes
causing the n number of first transistors to open the n number of respective first charge mixing paths, and
causing the n number of second transistors to open the n number of respective second charge mixing paths, and
wherein the second control include
causing the n number of first transistors to close the n number of respective first charge mixing paths, and
causing the n number of second transistors to close the n number of respective second charge mixing paths.
